(19) United States
(12) Patent Application Publication
(10) Pub. No.: US 2006/0268659 A1
(43) Pub. Date: Nov. 30, 2006

(54) BEATER APPARATUS AND METHOD

(76) Inventor: Randy Kaas, Phoenix, AZ (US)

Correspondence Address: WEISS & MOY PC, 4204 NORTH BROWN AVENUE, SCOTTSDALE, AZ, 85251, US

(21) Appl. No.: 11/279,373

(22) Filed: Apr. 11, 2006

Related U.S. Application Data
(60) Provisional application No. 60/685,222, filed on May 27, 2005.

(51) Int. Cl. B01F 7/18

(52) U.S. Cl. 366/312

(57) ABSTRACT

An improved beater apparatus and method having a blade extending from an outer edge of a motor-driven beater. The beater/blade combination is sized so that, during the mixing process, the blade will scrape batter from the interior walls of a mixing bowl in which the beater is operating. The scraping allows the batter to be driven toward the interior of the beater, for better mixing.

### RELATED APPLICATION

This application claims priority to U.S. patent application Ser. No. 60/685,222, filed in the name of the applicant on May 27, 2005.

### FIELD OF THE INVENTION

This invention relates generally to baking and, more specifically, to an improved beater apparatus and method.

### BACKGROUND OF THE INVENTION

When cooking or baking, certain ingredients are often mixed with an electric mixer. These mixers are equipped with various beaters, the shapes of which are particular to a specific type of mixing. For example, wire beaters are used to add air to whipped mixes such as whipped cream, and dough hooks are used for mixing and kneading yeast bread dough. The most commonly used beater is the flat beater, which is used for almost everything from heavy cookie dough batter to lighter cake mixtures.

A common problem with using electric mixers, however, is that much of the ingredients are pushed toward the interior walls of the mixing bowl, out of the beater's range. In order to solve this problem, some have resorted to using a small rubber spatula to scrape the sides of the mixing bowl and to manually push the ingredients back toward the beaters. This may prove to be dangerous, however, because there is great potential for the user's hand or the rubber spatula to be caught in the moving beaters. It is also inconvenient for the user to constantly have to tend to the mixer to ensure that the ingredients are being evenly and thoroughly mixed.

A need exists for a beater capable of scraping the interior walls of the mixing bowl during mixing in order to guide the ingredients toward the middle area of the beater.

### SUMMARY OF THE INVENTION

In accordance with one embodiment of the present invention, an improved beater apparatus is disclosed. The apparatus comprises: a motor-driven beater having an outer edge; a mixing bowl having an interior wall and dimensioned to hold batter that is to be mixed by the beater; and a blade extending from at least a portion of the outer edge of the beater; wherein, during use of the beater, the blade scrapes the batter from the interior wall of the mixing bowl.

In accordance with another embodiment of the present invention, an improved beater apparatus is disclosed. The apparatus comprises: a motor-driven beater having an outer edge; a mixing bowl having an interior wall and dimensioned to hold batter that is to be mixed by the beater; and a blade extending from at least a portion of the outer edge of the beater; wherein the blade is slidably coupled to the outer edge; wherein the blade extends from a bottom portion of the beater; and wherein, during use of the beater, the blade scrapes the batter from the interior wall of the mixing bowl.

In accordance with a further embodiment of the present invention, a method for mixing method comprising: providing a motor-driven beater having an outer edge; providing a mixing bowl having an interior wall and dimensioned to hold batter that is to be mixed by the beater; providing a blade extending from at least a portion of the outer edge of the beater; wherein, during use of the beater, the blade scrapes the batter from the interior wall of the mixing bowl; placing batter in the mixing bowl; and activating the beater; wherein, during use, the blade scrapes batter from the interior wall of the mixing bowl.

### BRIEF DESCRIPTION OF THE DRAWINGS

FIG. 1 is a top view of a beater consistent with an embodiment of the present invention.

FIG. 2 is a perspective view of the beater of FIG. 1.

FIG. 3 is a side view of the beater of FIG. 1.

FIG. 4 is a side view of the beater of FIG. 1.

FIG. 5 is a perspective view of the beater of FIG. 1, shown in use with a mixing bowl.

### DETAILED DESCRIPTION OF THE PREFERRED EMBODIMENTS

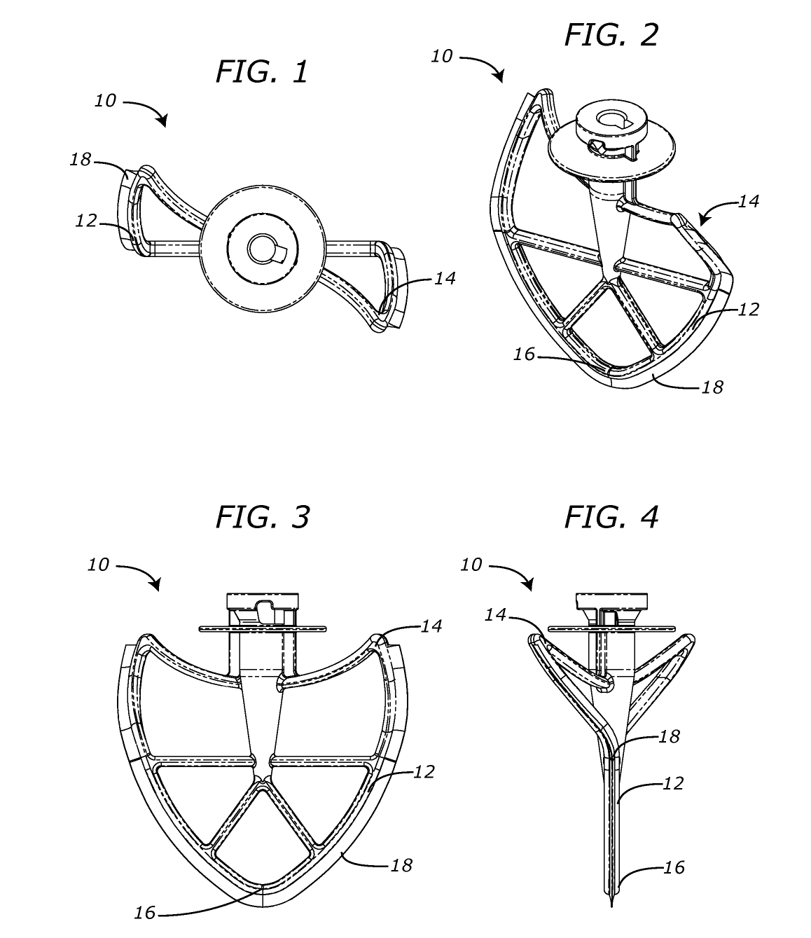

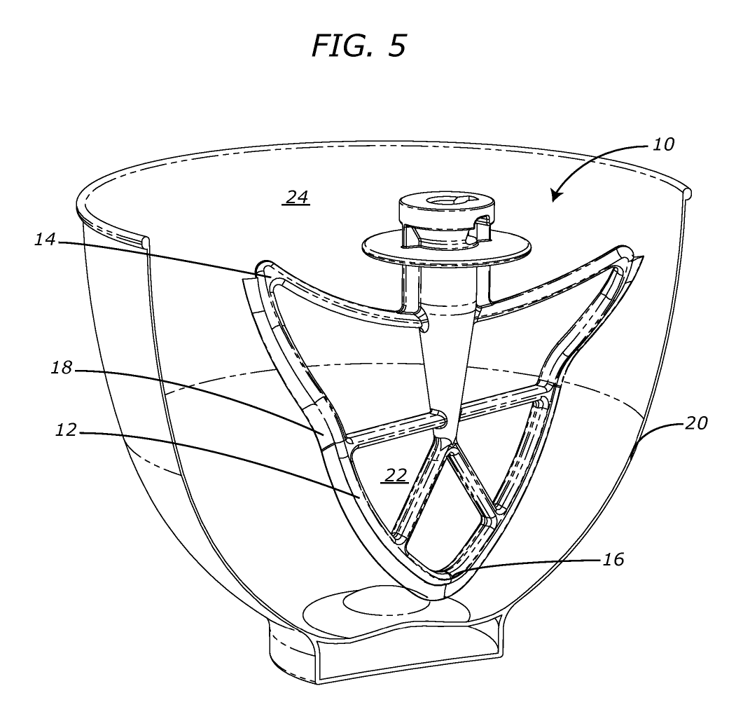

FIGS. 1-5 show a beater, hereinafter referred to as beater 10, consistent with an embodiment of the present invention. The beater 10 has a blade 18 slidably coupled to and extending from the edge 12 of the beater 10. Although it is preferred that the blade 18 be slidably coupled to the edge 12 of the beater 10 in order for the blade to be removed for cleaning, it should be clearly understood that substantial benefit may be derived from the blade 18 being coupled to the edge 12 of the beater 10 in an alternative manner or from the blade 18 being integral with the edge 12 of the beater 10.

The blade 18 is dimensioned to scrape the interior walls 24 (see FIG. 5) of the mixing bowl 20 (see FIG. 5) during mixing. In one embodiment, the blade 18 may cover the top portions 14 of the edge 12 of the beater 10, although it should be clearly understood that substantial benefit may nevertheless be derived if the blade 18 does not cover the top portions 14 of the edge 12 of the beater 10 as long as the blade 18 covers at least a portion of the edge 12 of the beater 10. As shown, the top portions 14 of the edge 12 of the beater 10 may curve slightly inwardly. The portion of the blade 18 coupled to and extending from the slightly inwardly curving top portions 14 aid in guiding the ingredients (not shown) toward the middle area 22 (see FIG. 5) of the mixing bowl 20 for more thorough mixing. While the top portions 14 of the edge 12 of the beater 10 may curve slightly inwardly, it should be clearly understood that substantial benefit may still be derived from substantially straight top portions 14 of the edge 12 of the beater 10.

The blade 18 may be comprised of any desired material suitable for use with a mixing bowl for performing the scraping function as herein described. This may include metal, plastic, rubber, silicone, etc. It should also be noted that, as described herein, the beater 10 may be specifically adaptable to reverse orbitable offset of the motor action.

While the invention has been particularly shown and described with reference to preferred embodiments thereof, it will be understood by those skilled in the art that the foregoing and other changes in form and details may be made therein without departing from the spirit and scope of the invention. For example, while, in the preferred embodiment, the beater 10 is a flat beater, it should be clearly understood that substantial benefit could be derived from an alternatively shaped beater 10. And although the blade 18 is shown as preferably covering the bottom portion 16 (see FIGS. 2-6) of the beater 10, it should be understood that substantial benefit may nevertheless be derived if the blade 18 did not cover the bottom portion 16 of the beater. Furthermore, although it is preferred that the blade 18 comprise one piece, it should be clearly understood that the blade 18 may comprise multiple sectional pieces.

I claim:

1. An improved beater apparatus comprising:
a motor-driven beater having an outer edge;
a mixing bowl having an interior wall and dimensioned to hold batter that is to be mixed by the beater; and
a blade extending from at least a portion of the outer edge of the beater;
wherein, during use of the beater, the blade scrapes the batter from the interior wall of the mixing bowl.

2. The apparatus of claim 1 wherein the blade is slidably coupled to the outer edge.

3. The apparatus of claim 1 wherein the blade is an integral part of the outer edge of the beater.

4. The apparatus of claim 1 wherein the outer edge has an inwardly turning top portion.

5. The apparatus of claim 1 wherein the beater is a flat beater.

6. The apparatus of claim 1 wherein the blade extends from a bottom portion of the beater.

7. The apparatus of claim 1 wherein the blade is a one-piece assembly.

8. An improved beater apparatus comprising:
a motor-driven beater having an outer edge;
a mixing bowl having an interior wall and dimensioned to hold batter that is to be mixed by the beater; and
a blade extending from at least a portion of the outer edge of the beater;
wherein the blade is slidably coupled to the outer edge;
wherein the blade extends from a bottom portion of the beater; and
wherein, during use of the beater, the blade scrapes the batter from the interior wall of the mixing bowl.

9. The apparatus of claim 8 wherein the outer edge has an inwardly turning top portion.

10. The apparatus of claim 8 wherein the beater is a flat beater.

11. The apparatus of claim 8 wherein the blade is a one-piece assembly.

12. A mixing method comprising:
providing a motor-driven beater having an outer edge;
providing a mixing bowl having an interior wall and dimensioned to hold batter that is to be mixed by the beater;
providing a blade extending from at least a portion of the outer edge of the beater;
wherein, during use of the beater, the blade scrapes the batter from the interior wall of the mixing bowl;
placing batter in the mixing bowl; and
activating the beater;
wherein, during use, the blade scrapes batter from the interior wall of the mixing bowl.

13. The method of claim 12 wherein the blade is slidably coupled to the outer edge.

14. The method of claim 12 wherein the blade is an integral part of the outer edge of the beater.

15. The method of claim 12 wherein the outer edge has an inwardly turning top portion.

16. The method of claim 12 wherein the beater is a flat beater.

17. The method of claim 12 wherein the blade extends from a bottom portion of the beater.

18. The method of claim 12 wherein the blade is a one-piece assembly.
